(19) United States
(12) Patent Application Publication
(10) Pub. No.: US 2008/0313240 A1
(43) Pub. Date: Dec. 18, 2008

(54) Method for Creating Data Transfer Packets With Embedded Management Information

(76) Inventors: Ronald E. Freking, Rochester, MN (US); Ryan S. Haraden, Rochester, MN (US); Paul J. Mattos, Jericho, VT (US); Adalberto G. Yanes, Rochester, MN (US)

Correspondence Address: Robert R. Williams;IBM Corporation, Dept. 917, 3605 Highway 52 North, Rochester, MN, 55901-7829, US

(21) Appl. No.: 11/764,310

(22) Filed: Jun. 18, 2007

(51) Int. Cl. G06F 17/30; G06F 3/00

(52) U.S. Cl. 707/201; 707/E17.001

(57) ABSTRACT

In a method of communicating management information from a completing entity to a requesting entity in a digital communication system, the availability of management information to be sent from the completing entity to the requesting entity is detected when generating a data packet that does not have a primary purpose of transmitting management information. The management information is included in a management information data field and the management information data field is appended to the data packet. The data packet and the management information are transmitted from the completing entity to the requesting entity.

### BACKGROUND OF THE INVENTION

1. Field of the Invention

The present invention relates to digital communication systems and, more specifically, to an enhancement for multi-lane digital communications protocols.

2. Description of the Prior Art

Multi-lane digital communications systems allow computer processors to communicate with a variety of other devices in a highly flexible manner. Such systems employ a plurality of different data channels (sometimes referred to as “lanes”) that communicate with all of the devices in a network. A lane is a serial point-to-point connection that connects a “root” device to an “endpoint” device. The lanes can be configured as serial data channels, or they can be grouped together to act as parallel data busses, depending on the requirements of the specific device connected to the system.

One type of multi-lane digital communication system is referred to as “PCI Express.” PCI Express is a digital communications standard that allows expansion cards to be added to a computer system. The first generation of PCI Express allows data transfer over 32 different lanes. Each allows a data transfer rate of 250 MB per second and, thus, the total data transfer rate for all lanes is 8 GB per second (other generations will have different data transfer rates). PCI Express also includes a plurality of serial interconnects. A single hub with many pins connects a central unit (such as the mother board of a computer) to the PCI Express bus.

The PCI Express communications protocol is layered. The layers include: a transaction layer, a data link layer; and a physical layer. The physical layer is divided into a logical sublayer and an electrical sublayer. The logical sublayer is frequently further divided into a physical coding sublayer (PCS) and a media access control (MAC) sublayer. In the electrical sublayer, each lane includes two unidirectional low voltage differential signaling (LVDS) conductor pairs that transmit data at 2.5 gigabits per second. Transmit and receive functions use different LDVS pairs, resulting in four conductors per lane.

PCI Express sends all control messages, including interrupts, over the same links used for data. The serial protocol can never be blocked. Data transmitted on multiple-lane links is interleaved so that each successive byte is transmitted on a different lane in a process referred to as “data striping.”

The data link layer (DLL) sequences transaction layer packets (TLPs) that are generated by the transaction layer. The DLL also provides data protection via a 32-bit cyclic redundancy check code (referred to as “LCRC”) and an acknowledgement protocol. When a TLP passes an LCRC check and a sequence number check, an acknowledgement (ACK) is returned. When a TLP fails the LCRC check, a negative acknowledgement (NAK) is sent. TLPs that result in a NAK, or timeouts that occur while waiting for an ACK, result in the TLPs being replayed from a buffer in the transmit data path of the DLL. ACK and NAK signals are communicated via a low-level packet known as a data link layer packet, or DLLP. DLLPs are also used to communicate flow control information between the transaction layers of two connected devices, as well as some power management functions.

PCI Express allows transactions with a request and a response that are separated by time. This enables the link to carry other traffic while the target device gathers data for the response. PCI Express uses credit-based flow control to communicate receive buffer status from a receiver to a transmitter to prevent buffer overflow and to allow transmitter compliance with ordering rules. With flow control, a device at one end of a link advertises an initial number of credits for each of the receive buffers in its transaction layer. When sending transactions to this device, the device at the other end of the link counts the number of credits consumed by each TLP from its account. The sending device may only transmit a TLP when doing so does not result in its consumed credit count exceeding its credit limit. When the receiving device finishes processing the TLP from its buffer, it signals a return of credits to the sending device, which then increases the credit limit by the restored amount.

In PCI Express, flow control (FC) is used to prevent overflow of receiver buffers and to enable compliance with ordering rules. The flow control mechanism is used by a requester to track the queue or buffer space available in an agent across a link. Flow control is point-to-point (across a link) and not end-to-end.

Flow control is separate from the data integrity mechanisms used to implement reliable information exchange between a transmitter and a receiver. Each virtual channel maintains an independent flow control credit pool. The FC information is conveyed between two sides of the link using DLLPs. The VCID field of the DLLP is used to carry the Virtual Channel Identification that is required for proper flow-control credit accounting.

Flow Control is handled by the transaction layer in cooperation with the data link layer. The Transaction Layer performs flow control accounting functions for Received TLPs and “gates” TLP Transmissions based on available credits for transmission.

Flow control is a function of the Transaction Layer and, therefore, the following types of information transmitted on the interface are not associated with Flow Control Credits: LCRC, Packet Framing Symbols, other Special Symbols, and Data Link Layer to Data Link Layer intercommunication packets. These types of information must be processed by the receiver at the rate they arrive. Any TLPs transferred from the transaction layer to the data link and physical Layers must have first passed the flow control “gate.” Thus, both transmit and receive flow control mechanisms are unaware if the data link layer transmits a TLP repeatedly due to errors on the link.

One example of an existing digital communication system 10 that employs flow control is shown in FIG. 1A. The system 10 includes a root complex 12 that is in communication with a switch 14, which is in communication with an endpoint 16. End-to-end communications between the endpoint 16 and the root complex 12 are accomplished through a series of links. For example, when requesting data from the endpoint 16, the root complex 12 transmits a request to the switch 14. The switch 14 then transmits the request to the endpoint 16. The endpoint 16 transmits the requested data to the switch 14, which transmits it to the root complex 12. The same linking process is employed when the root complex 12 writes data to the endpoint 16.

Each node (12, 14 & 16) in such a system employs a buffer to facilitate the efficient receipt of data. However, if the rate at which a node receives data is faster than the rate at which the data is taken out of the buffer by the node, data will be lost. To prevent this, the system 10 employs a flow control system in which each node transmits a flow control packet 18 that indicates the capacity of the node's buffer to the nodes with which it is communicating. In this way, a sending node will not send data to a receiving node unless the buffer of the receiving node has the capacity to receive the data.

A typical data stream 20 from such a system is shown in FIG. 1B. In such a data stream, a node will transmit data packets 22 and periodically transmit flow control packets 24. The flow control packets include administrative information in the form of a header and flow control information. The amount of flow control information in a data packet requires relatively few bits. However, a header is added to any packet being transmitted in a multi-lane system, including data packets used to transmit flow control information. Therefore, while flow control is necessary in a multi-lane system, it adds a substantial amount of bus overhead.

Therefore, there is a need for a system the employs flow control without adding unnecessary overhead.

### SUMMARY OF THE INVENTION

The disadvantages of the prior art are overcome by the present invention which, in one aspect, is a method of communicating management information from a completing entity to a requesting entity in a digital communication system, in which the availability of management information to be sent from the completing entity to the requesting entity is detected when generating a data packet that does not have a primary purpose of transmitting management information. The management information is included in a management information data field and the management information data field is appended to the data packet. The data packet and the management information are transmitted from the completing entity to the requesting entity.

In another aspect, the invention is a method of communicating flow control information from a completing entity to a requesting entity in a PCI Express system. A value of a flag that, when in a first state, indicates that flow control information is to be included with a data packet is detected. An extended data packet that includes a non-flow control data field and a flow control field is created when the flag is in the first state. Non-flow control data is written to the non-flow control data field and flow control data is written into the flow control field. The extended data packet is sent to a requesting entity.

In yet another aspect, the invention is a method of managing digital communications, in which a data packet to be sent from an endpoint to a root complex is created. A management information packet is appended to the data packet. The management information packet includes a flow control field for transmitting flow control information indicative of buffer availability at the endpoint. The data packet and the management information packet are transmitted to the root complex.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram of a prior art digital communication system.

FIG. 1B is a schematic diagram of a prior art data stream from the system shown in FIG. 1A.

FIG. 2 is a schematic diagram of a data stream from the system that transmits management information with data.

FIG. 3 is a schematic diagram of a system that generates a data stream of the type shown in FIG. 2.

FIG. 4A is a schematic diagram of a data packet that includes flow control data in a header.

FIG. 4B is a schematic diagram of a data packet that includes flow control data in a digest.

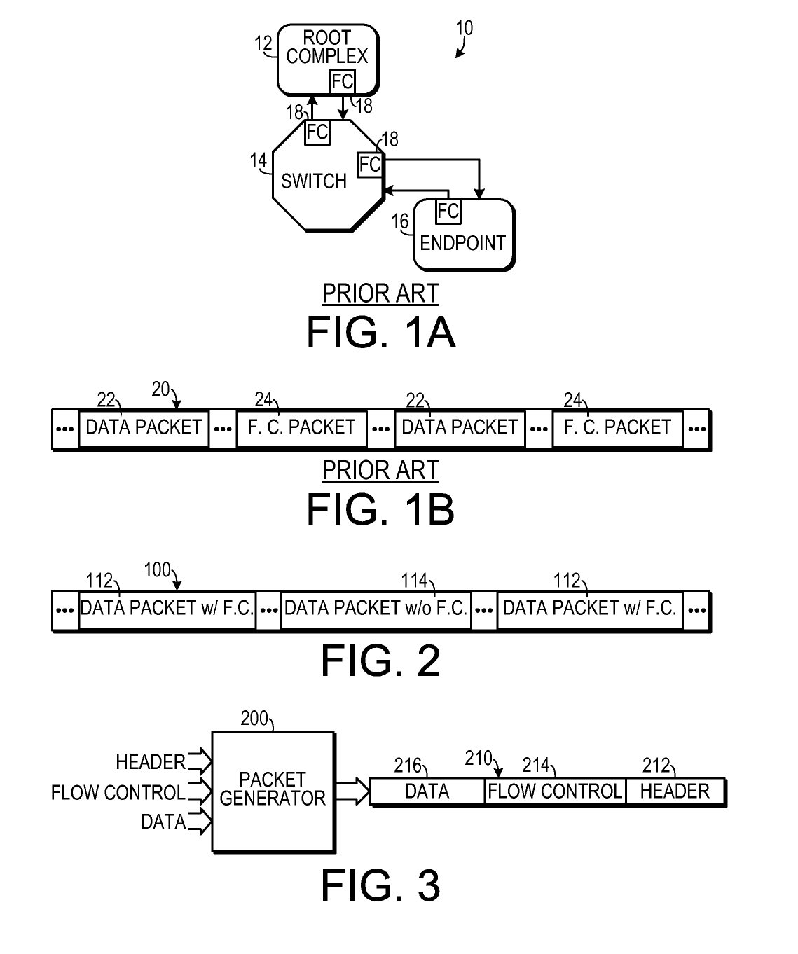

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Management information can be transmitted between nodes in a link that is part of a multi-link system with greater efficiency by including the management information with a regular data packet when such management information becomes available, rather than sending the management information in a separate packet. Such management information can include, for example: flow control information, which advertises buffer credit availability; acknowledgements (“ACKS”); and negative acknowledgements (“NACKS”).

In a typical PCI Express embodiment, the system generates an ordinary data packet (a data packet that does not have a primary purpose of transmitting flow control information) and detects when flow control information is available to be sent from the completing entity to a requesting entity. The data packet includes a flag that, when set, indicates that it is configured to include both regular data and flow control information.

The flow control information is added to the data packet as part of either a header or a digest. While a data packet is generated for an endpoint-to-endpoint transmission, the flow control information in the packet can be re-written for each link. For example, an endpoint could generate a data packet that includes flow control information indicative of the buffer capacity of the endpoint and then transmit the packet to a switch, which would use the flow control information from the endpoint in managing the amount of data it sends to the endpoint. The switch would write over the flow control information with flow control information indicative of the buffer capacity of the switch and then send the packet to a root complex, which would use the flow control information from the switch in managing the amount of data it sends to the switch. In cases where a switch has receives flow control information from an endpoint, but does not have flow control information to send to the root complex, a null value can be written to the flow control field in the data packet.

In one embodiment, the system adds one double word into a normal TLP packet. The new double word contains the management information. This improvement will help designs with multiple virtual lanes significantly but will also benefit non-virtual lane designs.

As shown in FIG. 2, one example of a data stream 100 between two nodes in a link could include a series of data packets with both non-flow control data and flow control data 112 and data packets with only non-flow control data 114. A receiving node could detect the difference between the two types of data packets by detecting the value of a flag in the header of the packet (e.g., a “0” indicates that no flow control field is present, whereas a “1” indicates that a flow control field is present). Currently, there are several bits in a PCI express header that are reserved and any of these bits could be used as the flag.

Conceptually, as shown in FIG. 3, header information, flow control information and ordinary data would be assembled by a packet generating entity 200, which could be implemented either as a software construct or as a hardware entity and which would assemble the data packets 210. When flow control information is to be sent, a typical data packet 210 would include a header 212, a flow control data field 214 and an ordinary data field 216.

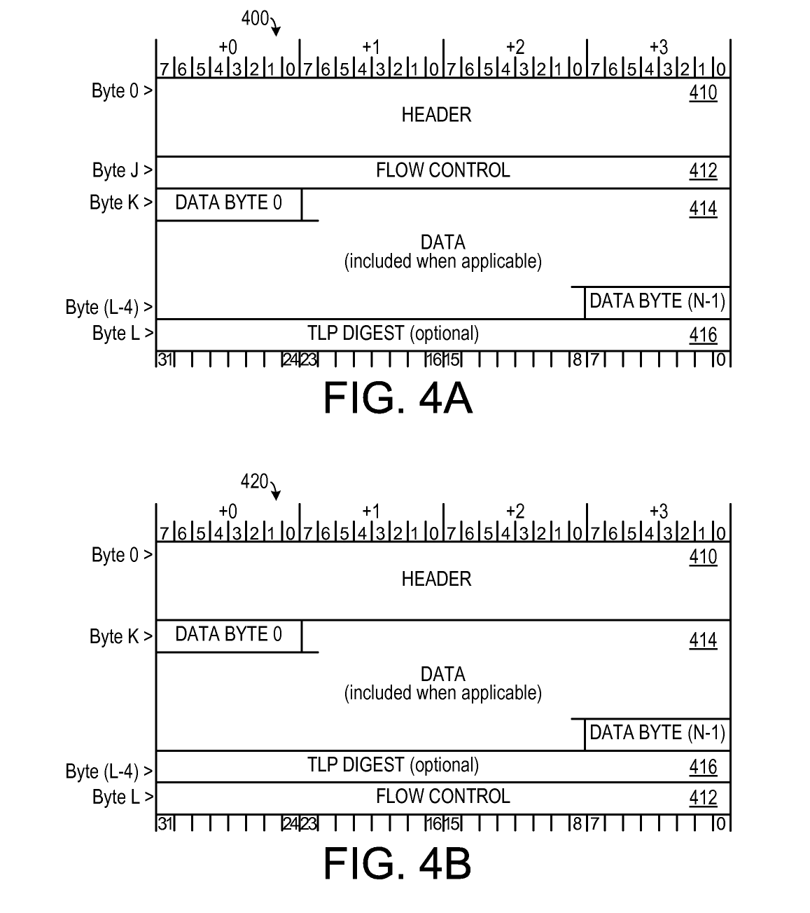

One example of a data packet 400 that would be used to transmit flow control information in a PCI Express embodiment is shown in FIG. 4A. Such a data packet 400 would include a header 410 followed by a flow control data field 412, which would be followed by three or four double words of ordinary data 414, which would then followed by an optional digest 416. An alternate example of a data packet 420 is shown in FIG. 4B, in which the flow control data field 414 is appended to the digest 416.

In one experimental embodiment, flow control link transmission improved by 50%. It also resulted in faster credit updates and reduced scheduling complexity. The system benefited by not having to wait for a gap in the data transmission to send the flow control information.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of communicating management information from a completing entity to a requesting entity in a digital communication system, comprising the actions of:
a. when generating a data packet that does not have a primary purpose of transmitting management information, detecting when management information is available to be sent from the completing entity to the requesting entity;
b. including the management information in a management information data field and appending the management information data field in the data packet; and
c. transmitting the data packet and the management information from the completing entity to the requesting entity.

2. The method of claim 1, wherein the management information comprises flow control information.

3. The method of claim 1, wherein the management information comprises acknowledgements and negative acknowledgements.

4. The method of claim 1, wherein requesting entity comprises a first node in a multi-link system and wherein the completing entity comprises a second node in the multi-link system.

5. The method of claim 4, wherein the multi-link system comprises a PCI Express system.

6. The method of claim 4, wherein the first node comprises a root complex and wherein the second node comprises a switch and wherein the management information comprises data indicative of buffer availability of the switch.

7. The method of claim 4, wherein the first node comprises a switch and wherein the second node comprises an endpoint and wherein the management information comprises data indicative of buffer availability of the endpoint.

8. The method of claim 1, wherein the including action comprises placing the management information in a selected one of a header or a digest.

9. The method of claim 1, further comprising the action of placing a null value in the management information data field when a data packet is being sent and when no management information is available to be sent to the requesting entity.

10. A method of communicating flow control information from a completing entity to a requesting entity in a PCI Express system, comprising the actions of:
a. detecting a value of a flag that, when in a first state, indicates that flow control information is to be included with a data packet;
b. when the flag is in the first state, creating an extended data packet that includes a non-flow control data field and a flow control field;
c. writing non-flow control data to the non-flow control data field and writing flow control data into the flow control field; and
d. sending the extended data packet to a requesting entity.

11. The method of claim 10, wherein the flow control data comprises a null value when no flow control information is available to be transmitted.

12. The method of claim 10, wherein requesting entity comprises a first node in a multi-link system and wherein the completing entity comprises a second node in the multi-link system.

13. The method of claim 12, wherein the first node comprises a root complex and wherein the second node comprises a switch and wherein the flow control data comprises data indicative of buffer availability of the switch.

14. The method of claim 12, wherein the first node comprises a switch and wherein the second node comprises an endpoint and wherein the flow control data comprises data indicative of buffer availability of the endpoint.

15. The method of claim 10, wherein the action of writing flow control data comprises placing the flow control data in a selected one of a header or a digest.

16. A method of managing digital communications, comprising the actions of:
a. creating a data packet to be sent from an endpoint to a root complex;
b. appending a management information packet to the data packet, wherein the management information packet includes a flow control field for transmitting flow control information indicative of buffer availability at the endpoint; and
c. transmitting the data packet and the management information packet to the root complex.

17. The method of claim 16, wherein the digital communication is executed over a multi-link system, wherein the endpoint communicates with at least one link node and the link node communicates with the root complex.

18. The method of claim 17, wherein the multi-link system comprises a PCI Express system.

19. The method of claim 17, further comprising the actions of:
a. receiving the data packet and the management information packet from the endpoint at the link node;
b. writing over the flow control information indicative of buffer availability at the endpoint with flow control information indicative of buffer availability at the link node; and
c. transmitting the data packet and the management information packet that includes flow control information indicative of buffer availability at the link node to the root complex.
